(19) United States
(12) Patent Application Publication
(10) Pub. No.: US 2015/0057950 A1
(43) Pub. Date: Feb. 26, 2015

(54) SYSTEM AND METHOD FOR MONITORING TRIBOLOGICAL LEVELS

(71) Applicant: Safe Space Ingenuity, Inc., Lynbrook, NY (US)

(72) Inventors: Timothy J. Vassallo, Lynbrook, NY (US); Robert W. Vassallo, JR., Lynbrook, NY (US); Patricia E. Vassallo, Lynbrook, NY (US)

(21) Appl. No.: 14/459,821

(22) Filed: Aug. 14, 2014

Related U.S. Application Data
(60) Provisional application No. 61/868,648, filed on Aug. 22, 2013.

(51) Int. Cl. G01N 19/00; G01N 19/02

(52) U.S. Cl. CPC G01N 19/00; G01N 19/02
USPC 702/33

(57) ABSTRACT

A method for monitoring tribological levels of a surface of a location is provided including the steps of receiving tribological data generated by a tribometer, where the tribological data corresponds to at least one tribological level of a surface of at least one location, associating the tribological data with a floor plan representing the at least one location, and displaying the tribological data on the floor plan for viewing on a computing or remote device.

### CROSS-REFERENCE TO RELATED APPLICATION

The present application claims the benefit of and priority to a U.S. Provisional Application No. 61/868,648 filed Aug. 22, 2013, the entire contents of which are incorporated by reference herein.

### TECHNICAL FIELD

The present disclosure relates generally to monitoring tribological levels, and more particularly to a system and method for monitoring tribological levels of a location and displaying the tribological level data monitored.

### BACKGROUND

Contact between two “flat” surfaces is made up of millions of microscopic points, called asperities, which interlock forming junctions. These junctions are the basis of defining surface slip resistance. Contact between each surface is altered due to the presence of contaminants between the two surfaces. Contaminants often act as lubricants which reduce surface friction, and in turn reduce slip resistance, causing a surface to be slippery.

Surface contamination is one of the main causes of slip and fall accidents. According to the National Safety Council, millions of Americans are injured annually from slips, trips, and falls. Falls are one of the leading causes of unintentional injuries in the United States, sending approximately 8.9 million people to the emergency department (2011 NSC Injury Facts). Falls are the second-leading cause of unintentional death in homes and communities, resulting in more than 25,000 fatalities in 2009.

When “Slip and Fall” accidents occur, there are two types of victims. The first being the person who actually falls and incurs injury to his/her person. The second is the property owner or manager of the space where the incident occurred. The property owner and/or manager may suffer financial repercussions, either directly or from their insurance carrier.

Therefore, there exists a need to efficiently manage and monitor the surfaces of a location, in particular, the tribological levels of the surfaces of the location.

### SUMMARY

Aspects of the present disclosure are directed to a system, method, and computer readable recording medium capable of monitoring tribological levels of a location and displaying the tribological levels on a floor plan representing the location and the specific surface where the tribological levels are dangerously low.

In accordance with aspects of the present disclosure a method for monitoring tribological levels of a surface of a location is provided including receiving tribological data generated by a tribometer, where the tribological data corresponds to at least one tribological level of a surface of at least one location, associating the tribological data with a floor plan representing the at least one location, and displaying the tribological data on the floor plan for viewing on a computing or remote device.

Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

### BRIEF DESCRIPTION OF THE DRAWINGS

For a more complete understanding of the present disclosure and its features and advantages, reference is now made to the following description, taken in conjunction with the accompanying drawings, in which:

FIG. 1 is a schematic illustration of a system for monitoring tribological levels of a location, according to an embodiment of the present disclosure;

FIG. 2 is a schematic illustration of a remote device of the system of FIG. 1, according to an embodiment of the present disclosure;

FIG. 3 is a schematic illustration of a data processing server of the system of FIG. 1, according to an embodiment of the present disclosure;

FIG. 4 is a flow chart depicting a method for monitoring tribological levels of a location using the system of FIG. 1, according to an embodiment of the present disclosure;

FIG. 5 is a flow chart of the method of FIG. 4, according to an embodiment of the present disclosure;

FIG. 6 is an illustration of a graphical user interface of a remote device illustrating a floor plan representing a location prior to receiving tribological levels of the location, according to an embodiment of the present disclosure; and

FIG. 7 is an illustration of a graphical user interface of a remote device illustrating an updated floor plan of FIG. 6 after receiving the tribological levels of the location, according to an embodiment of the present disclosure.

### DETAILED DESCRIPTION

The present disclosure incorporates the use of a system to monitor a surface of a location by monitoring tribological levels of the location.

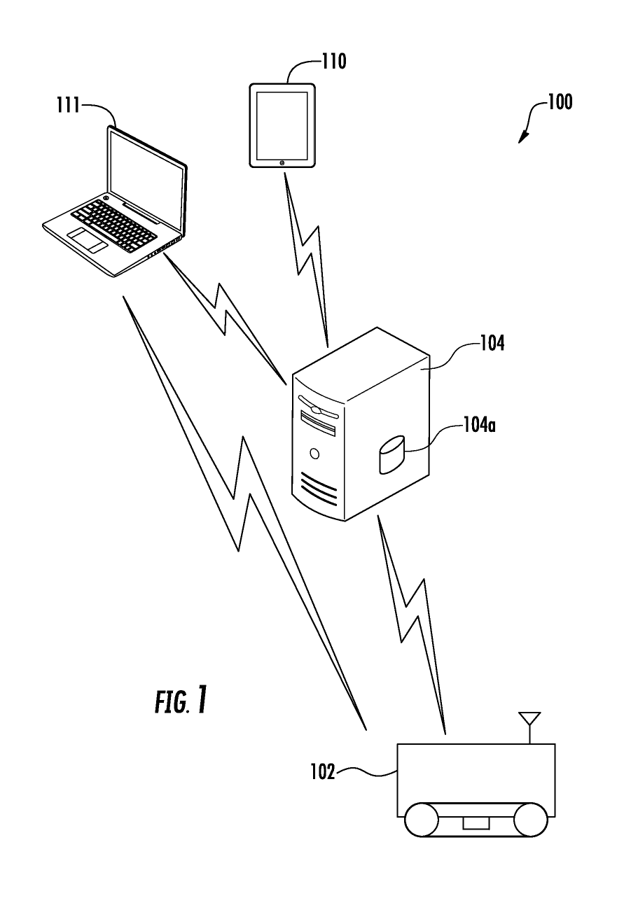

FIG. 1 illustrates one embodiment of a system 100 for monitoring tribological levels of a location. System 100 includes one or more data processing servers 104, communicatively coupled to one or more tribometers 102, and to one or more remote devices 110 and/or computing devices 111. Although this particular implementation of system 100 is illustrated and primarily described, the present disclosure contemplates any suitable implementation of system 100 according to particular needs of the institution or facility.

As noted above, system 100 includes one or more tribometers 102. In embodiments, the tribometers 102 generate tribological levels of the surface of a location. Tribological levels may include measured coefficient of friction (COF) values of the surface of the location. COF values are calculated by dividing the horizontal force (Fh) required to move a weight with the vertical force (Fv) associated with the weight. Thus, the tribometer 102 may calculate the COF between two given surfaces, such as the tribometer 102 (or a surface of a slider located on the tribometer 102) and the surface of the location. In other words, calculating the COF (μ) between two surfaces (e.g., a shoe and the floor) is defined as the horizontal force (Fh) required inducing a slip, divided by the normal vertical downward force (Fn). COF (μ) is represented by formula (I₁) below:

(I₁)μ=Fh/Fn.

Tribometers 102 may be any devices that are used for monitoring, tracking or generating tribological levels of a given surface in a location. In embodiments, tribometers 102 may be included on a robotic device that traverses the surface of a location. The robotic device may be automated or alternatively may be operated by a user. In the automated embodiment, the tribometer 102 either stores or is configured to receive location data associated with the surface of the location which the tribometer 102 traverses. In this regard, tribometer 102 may store floor plans of the locations. Alternatively, in one embodiment, data processing server 104 may store a plurality of floor plans representing a plurality of locations and may transmit the floor plan data to the tribometer 102.

Tribometers 102 may display the tribological levels on a display of the tribometer 102 or another suitable display, including, but not limited to displays of remote device 110, computing device 111, and/or data processing server 104. Tribometers 102 are communicatively coupled to any one of the remote device 110, computing device 111, and/or data processing server 104 such that signals and data may be transmitted between tribometers 102 and remote device 110, computing device 111, and/or data processing server 104. The tribological levels generated by the tribometer 102 may be: constantly streamed to the data processing server 104, periodically posted to the data processing server 104, or the data processing server 104 may periodically poll the tribometer 102 for the tribological levels. Further, other protocols may be employed based on monitored conditions, such that the data processing server 104 receives important data in a timely manner, regardless of any set period for collection of the tribological levels. Tribometers 102 may be communicatively coupled to remote device 110, computing device 111, and/or data processing server 104 via any suitable data connection. Suitable connections include networks such as a LAN, WAN, or WiLAN employing one or more of wired or wireless connections.

The term “wireless connection” as used herein includes any of a plurality of communications standards, protocols and technologies, including but not limited to, Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS), and/or Short Message Service (SMS)), or any other suitable communication protocol, including communication protocols not yet developed as of the filing date of this disclosure, and combinations thereof.

In embodiments, tribological levels may be stored on a removable storage device included in or coupled to the tribometer 102, such that a user may remove the removable storage device and hardwire the removable storage device to the data processing server 104.

Data processing server 104 includes one or more electronic computing devices operable to receive, transmit, process, and store data associated with system 100, in particular, the tribological levels received from tribometers 102 and other tribological levels in database 104a. Data processing server 104 uses any suitable operating system, as would be understood by those of ordinary skill in the art. Although a single data processing server 104 is illustrated, the present disclosure contemplates system 100 including any suitable number of data processing servers 104. Moreover, although referred to as a data processing server, the present disclosure contemplates data processing server 104 comprising any suitable type of processing or computing device or devices (e.g., cloud computing).

Data processing server 104 includes a database 104a which stores all data received from the remote devices 110, computing device 111, and tribometers 102. In particular, database 104a stores data corresponding to tribological levels generated by different tribometers 102, which are monitoring different locations and stores the received tribological levels as historical tribological levels corresponding to the particular location being monitored in database 104a for further processing.

In embodiments, data processing server 104 is configured to process all of the received and stored information and generate tribological level reports for review by a maintenance professional. In an embodiment, data processing server 104 hosts instructions that generate tribological level reports by filling in forms with the received tribological levels. In embodiments, the generated tribological level reports may be delivered to either or both of the remote devices 110 operated by users such as maintenance professionals or a computing device 111, as described in further detail below.

As noted above, data processing server 104 is communicatively coupled to either or both of one or more remote devices 110 and a computing device 111. Although illustrated and described as separate components, in embodiments, computing device 111 and data processing server 104 may be a single component. In embodiments, remote devices 110 and computing device 111 are communicatively coupled to data processing server 104 via a network such as a LAN, WAN, or WiLAN employing one or more of well-known network communication protocols, or may be hardwired to data processing server 104.

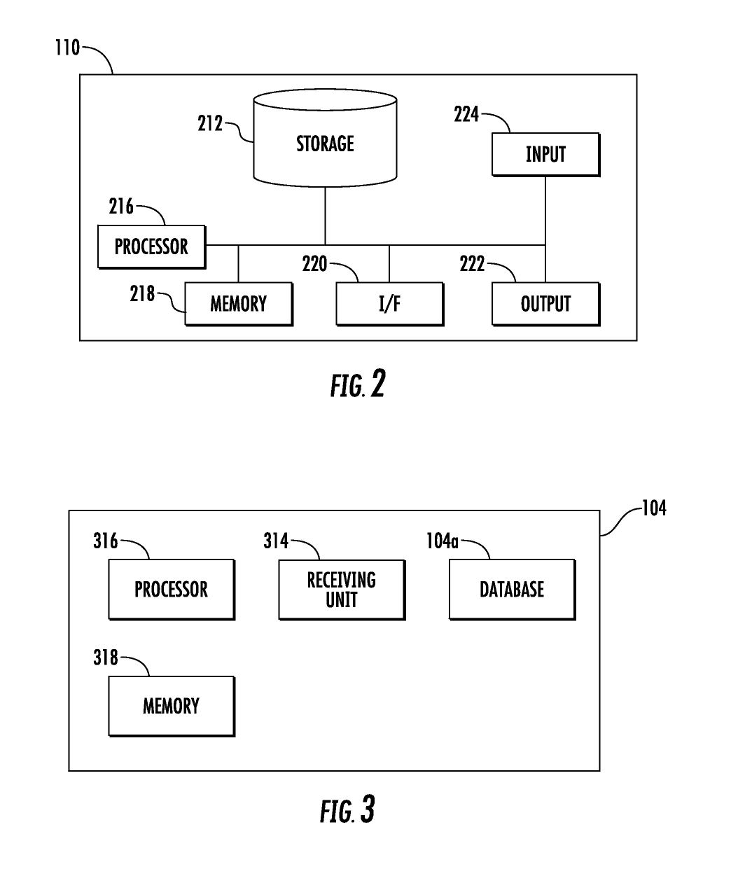

FIG. 2 illustrates a detailed schematic view of remote device 110 of system 100, according to certain embodiments of the present disclosure. Remote device 110 may be any device that provides output to, and can receive input from, a user. In embodiments, output at remote devices 110 may include audio, visual, haptic feedback, or any combination thereof. Each remote device 110 may include input components (including, but not limited to a keypad, touch screen, mouse, or other device that can accept input), output devices, mass storage media, or other suitable components for receiving, processing, storing, and communicating data.

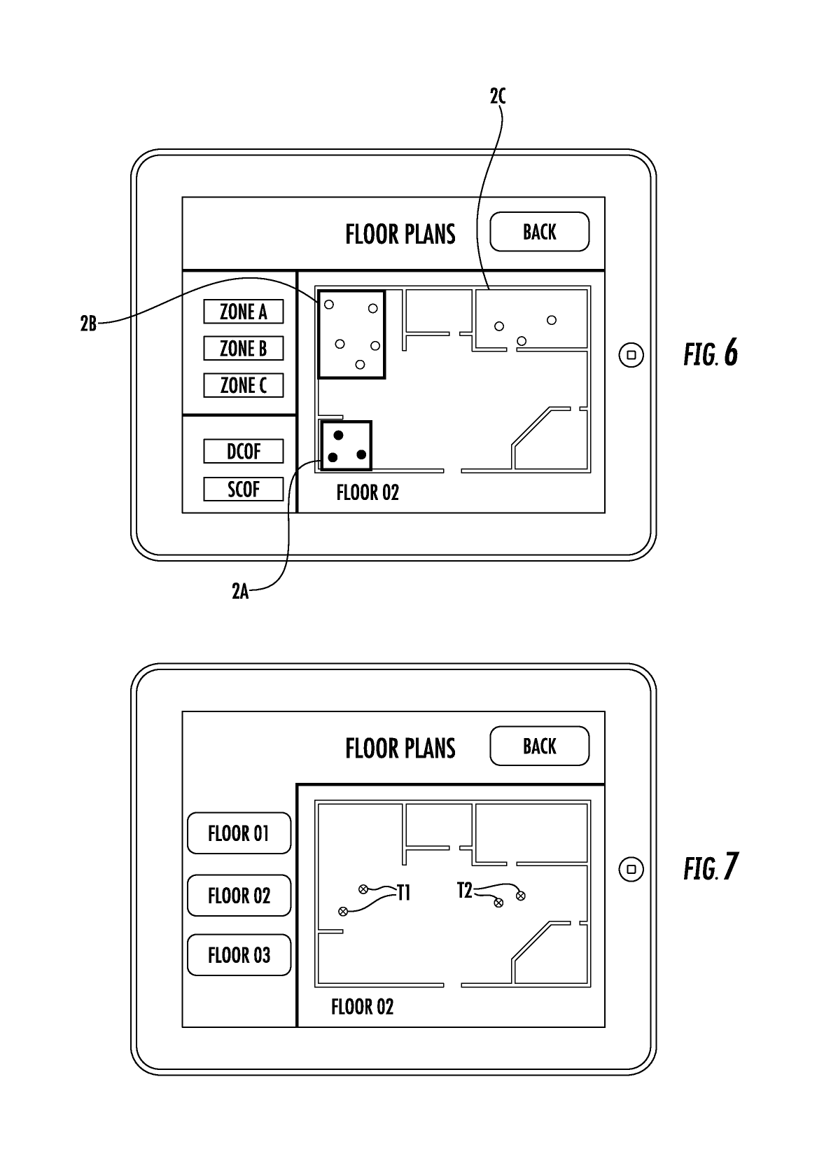

In embodiments, remote devices 110 may display one or more web pages in the form of graphical user interfaces (GUI's) (FIGS. 6 & 7), which may be hosted by data processing server 104, and display tribological level reports generated by the data processing server 104. The remote devices 110 may also receive data from any of the components of system 100, and transmit data to any of the components of system 100.

Remote device 110 includes a processor 216, a memory 218, a communication interface (I/F) 220, an output device 222, and an input device 224, which are described in further detail below. Although this particular implementation of remote device 110 is illustrated and primarily described, the present disclosure contemplates any suitable implementation of remote device 110 according to particular needs.

Continuing with reference to FIG. 2, storage device 212 is similar to database 104a and may include any suitable device operable for storing data and instructions, which may be executable by processor 216. Storage device 212 may include Random Access Memory (RAM) or Read Only Memory (ROM), Electrically Erasable Programmable Read-only Memory (EEPROM), a magnetic disk, flash memory, optical disk, or any other suitable data storage device, including any of those listed below with reference to memory 218.

Memory 218 and/or storage device 212 may include software or instructions that when executed by the processor 216 cause the processor 216 to perform any of the methods described herein. Examples of the instructions may include a “thick client”, i.e., a networked computer with most resources installed locally, rather than distributed over a network, such as a native application that runs on the remote device 110, receives data from the data processing server 104 and conducts its own processing and data manipulation. Alternatively, the instructions may be a “thin client” interface, i.e., a networked computer that depends heavily on a server to fulfill its computational roles, enabling display of data received from data processing server 104, and all processing and data manipulation occurs at the data processing server 104 and is made available via a browser such as, for example: Mozilla® (Firefox®), Internet Explorer®, Google Chrome®, Safari® or any other current or future browsers. Memory 218 may include any computer memory (e.g., RAM or ROM), mass storage media (e.g., a hard disk), removable storage media (e.g., a Compact Disk (CD), a Digital Video Disk (DVD), or USB Flash Drive), database and/or network storage (e.g., a server), or any combination thereof. Memory 218 may also include any other computer-readable tangible medium, or a combination of any of the preceding.

Processor 216 includes any suitable device operable to execute instructions and manipulate data to perform operations. Processor 216 may include any type of central processing unit (CPU) such as those available from Intel®, AMD®, TI®, Qualcomm®, and the like.

Interface (I/F) 220 includes any suitable device operable to receive input, send output, perform suitable processing of the input or output or both, communicate to other devices, such as other remote devices 110, tribometers 102, and/or data processing server 104, or any combination of the preceding. I/F 220 may include appropriate hardware (such as a modem, network interface card, etc.) and software, including protocol conversion and data processing capabilities, to communicate through a LAN, WAN, or other communication system that allows remote device 110 to communicate with other devices.

Output device 222 includes any suitable device operable for displaying information to a user, for example in the form of a graphical user interface (GUI) (FIGS. 6 & 7). Output device 222 may include, for example, a touch screen, a video display, a printer, a plotter, or other suitable output device. Input device 224 includes any suitable device operable to input, select, and/or manipulate various data and information. Input device 224 may include, for example, a touch screen, a keyboard, a mouse, a touchpad, joystick, light pen, microphone, scanner, or other suitable input device.

Modifications, additions, or omissions may be made to remote device 110 without departing from the scope of the present disclosure. The components of remote device 110 may be integrated or separated. Moreover, the operations of remote device 110 may be performed by more, fewer, or other components. Additionally, in some embodiments, remote devices 110 are configured to transmit data to the data processing server 104. The data processing server 104 may include a processing unit or processor and memory storing instructions that cause the processor to carry out any or all of the functions and/or methods described with respect to the processes carried out by the mobile devices 110.

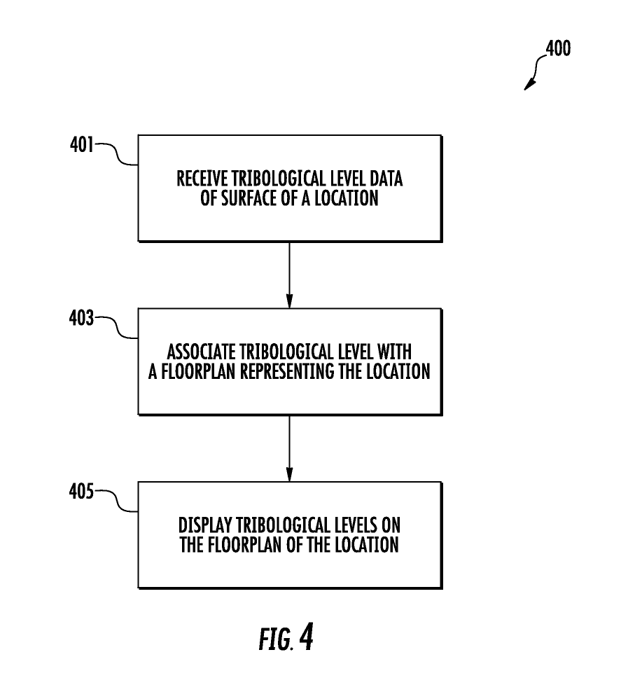

In particular, and turning now to FIG. 3, which illustrates a detailed view of a data processing server 104 of system 100, according to an embodiment of the present disclosure. Data processing server 104 includes a receiving unit 314, processor 316, memory 318, and database 104a. The processor 316 and memory 318 of data processing server 104 are similar to the processor 216 and memory 218 of remote device 110 (FIG. 2).

Receiving unit 314 may include any suitable device for receiving data from the mobile devices 110 and/or tribometers 102 for storage in database 104a and/or processing by the processor 316. In particular, receiving unit 314 receives the tribological levels generated by tribometers 102 monitoring surfaces for storage in the database 104a to carry out any of the methods and processes described below. The data received from remote devices 110 and tribometers 102 may be received by the receiving unit 314 or may be transmitted by the remote devices 110 and tribometers 102.

As noted above, database 104a stores all of the tribological levels, which may include real-time tribological levels generated by tribometers 102 that are monitoring surfaces, surface history and historical data, images of surfaces, etc. Database 104a may include multiple databases, which are communicatively linked to each other. In embodiments, database 104a includes a cloud storage area, which accesses multiple databases on multiple servers.

Database 104a also includes floor plans representing respective locations. Each floor plan stored in database 104a corresponds to one location. It is envisioned that system 100 may be used for multiple clients/users. In this regard, database 104a may include more than one database where each database is associated with a different client/user. Additionally, each client/user may have multiple locations (i.e., multiple floors of a building) that need to be monitored. Thus, database 104a may include multiple floor plans, each floor plan representing a different location (i.e., floor) of one or more users/clients.

Turning now to FIGS. 4 & 5, methods for monitoring tribological levels of a location are illustrated and will now be described. With reference also to FIGS. 1-3, the methods described herein are processes stored in the form of instructions in the memory 218, 318 of remote devices 110, computing device 111, data processing server 104, and/or tribometer 102, which when executed by the processor 216, 316, cause the processor 216, 316 to carry out the steps of any of the methods according to the present disclosure. It is envisioned that although the methods described herein are illustrated and described as including particular steps and are described as in a particular order, the methods may include some or all of the steps and may be arranged in any order not specifically described.

With particular reference to FIG. 4, a method for monitoring tribological levels of a location is illustrated and described as method 400. Method 400 begins at step 401 where data processing server 104 receives tribological levels from the surface of the location that a tribometer 102 is monitoring. As described above, in some embodiments, data processing server 104 receives the tribological level data from tribometers 102 in real-time. In other embodiments, the tribometer 102 stores the tribological levels in a storage unit, such as a removable storage media, and a user may transfer the stored data to any or all of the data processing server 104, remote devices 110, and/or computing device 111. As described above, tribological levels are generated by measuring the COF between the surface of the tribometer 102 (or the surface of a tribometer slider located on the tribometer 102) and the surface of the location. In embodiments, the tribometer 102 may be continuously traversing the surfaces of a location to generate new tribological levels of each surface of the location.

In step 403, data processing server 104 associates the received tribological levels with the specific floor plan representing the location being monitored.

In step 405, the tribological level data is displayed on the floor plan of the location. In one embodiment, the tribological level data is displayed on remote device 110 and/or computing device 111. In one embodiment, step 405 is carried out in real-time as the tribological levels are received. In this regard, data processing server 104 transmits the tribological data to the remote device 110 and/or computing device 111 subsequent to receiving the tribological levels from the tribometer 102, such that the remote device 110 and/or computing device 111 may display the values on the output device (i.e., a display device or monitor). In some embodiments, the tribological levels may be transmitted directly to the remote device 110 and/or computing device 111.

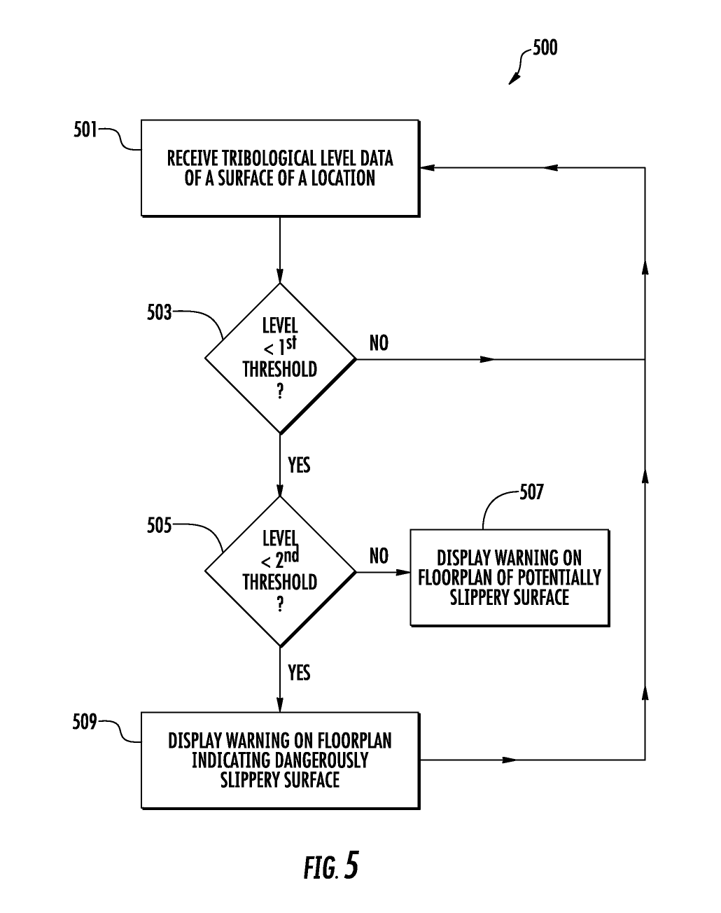

Turning now to FIG. 5, an exemplary method for monitoring tribological levels of a location and monitoring a surface is illustrated and described as method 500. Method 500 begins at step 501 where data processing server 104 receives the tribological level data of a surface of a location. In this regard, step 501 of method 500 is similar to step 401 of method 400.

Subsequent to receiving the tribological level data in step 501, in step 503, data processing server 104 determines if the value of the tribological level received in step 501 is less than a first preconfigured threshold. In embodiments, the first preconfigured threshold is adjustable by a user. Alternatively, in embodiments, the first preconfigured threshold is preset by a manufacturer, or may correspond to given standards. In embodiments, the first preconfigured threshold is COF (μ)=0.42. If the tribological level received is not less than the first preconfigured threshold (e.g., NO in step 503), then method 500 reverts to step 501, where a new tribological level is received corresponding to a new surface of the location being monitored. Alternatively, if the tribological level received is less than the first preconfigured threshold (e.g., YES in step 503), then method 500 proceeds to step 505.

In step 505, data processing server 104 determines if the tribological level received in step 501 is also less than a second predetermined threshold.

In embodiments, the second preconfigured threshold is also adjustable by a user. Alternatively, in embodiments, the second preconfigured threshold is preset by a manufacturer, or may correspond to given standards. In embodiments, the second preconfigured threshold is COF (μ)=0.30. If the tribological level received is less than the first preconfigured threshold, but not less than the second preconfigured threshold (e.g., NO in step 505), then method 500 proceeds to step 507. In step 507, data processing server 104 displays a first warning on a portion on the floor plan corresponding to the surface where the tribological levels are less than the first preconfigured threshold. Such a first warning may be indicative of a potentially slippery surface at the location.

Alternatively, if the tribological level received is less than the first preconfigured threshold, and is also less than the second preconfigured threshold (e.g., YES in step 505), then method 500 proceeds to step 509. In step 509, data processing server 104 displays a second warning on a portion of the floor plan corresponding to the surface where the tribological levels are less than the second preconfigured threshold. Such a second warning may be indicative of a highly slippery surface at the location and that professional intervention may be necessary. Subsequent to either or both of steps 507 or 509, method 500 reverts to step 501 where data processing server 104 receives a new tribological level generated for a new surface of the location being monitored.

FIG. 6 is one example of a graphical user interface of a remote device 110 and/or computing device 111 illustrating a floor plan representing a location prior to receiving tribological levels of the location. As illustrated, the floor plan can include different zones ZA, ZB, ZC of the location that may be prone to having lower tribological levels due to pre-existing conditions (e.g., lobby entrance, water source presence, etc.).

FIG. 7 is an example of a graphical user interface of a remote device 110 and/or computing device 111 illustrating the floor plan of a location being monitored, or a location that has already been monitored, by a tribometer 102, after receiving the tribological levels of the location. Targeted points of the floor plan that are being monitored are shown as T1 and T2. In embodiments, each of the zones ZA, ZB, ZC may include multiple points that are being monitored by the tribometer 102. The points T1 and T2 may be color-coded to represent the tribological levels. Points having tribological levels above the first threshold may be displayed in a first color (e.g., green) representing that the levels are safe. Points having tribological levels between the first and second threshold may be displayed in a second color (e.g., yellow) representing that the levels are cautionary and the slippery conditions should be addressed. Points having tribological levels below the second threshold may be displayed in a third color (e.g., red) representing that the levels are dangerous and immediate attention is required. In embodiments, the zones ZA, ZB, ZC may be color-coded similarly to the targeted points T1 and T2 to reflect the totality (e.g., mean, median, etc.) of the tribological levels measured in the zones. In further embodiments, a legend may be displayed, which corresponds to the user-defined tribological levels. Although not illustrated, in embodiments, system 100 may include more than two thresholds, each of which may be displayed as multiple colors.

Certain embodiments of the present disclosure comprise logic for monitoring tribological levels of a location, and may be embodied in at least one tangible, computer-readable medium. For example, portions of the logic may be embodied in one or more of tribometer 102, data processing server 104, and remote device 110 of system 100 in any manner.

Although the present disclosure describes certain embodiments, various alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. A method for monitoring tribological levels, comprising:
receiving tribological data generated by a tribometer, the tribological data corresponding to at least one tribological level of a surface of at least one location;
associating the tribological data with a floor plan representing the at least one location; and
displaying the tribological data on the floor plan.

2. The method according to claim 1, wherein the digital tribometer is a component of a robot that traverses the surface.

3. The method according to claim 2, wherein the robot traverses the surface based on location identifiers included in the floor plan.

4. The method according to claim 1, wherein the data is received wirelessly and in real-time.

5. The method according to claim 1, wherein the data is received via a hardwire connection.

6. The method according to claim 1, wherein the floor plan includes a graphical representation illustrating at least one change in property of the at least one tribological level from a previously received tribological level.

7. The method according to claim 6, wherein the graphical representation is color-coded.

8. A system for monitoring tribological levels, comprising:
a database storing a plurality of floor plans corresponding to a plurality of locations;
a processor; and
a memory storing instructions executable by the processor, wherein the instructions when executed by the processor cause the system to:
receive tribological data generated by a tribometer, the tribological data corresponding to at least one tribological level of a surface of at least one location;
associate the tribological data with a floor plan representing the at least one location; and
display the tribological data on the floor plan.

9. The system according to claim 8, wherein the digital tribometer is a component of a robot that traverses the surface.

10. The system according to claim 9, wherein the robot traverses the surface based on location identifiers included in the floor plan.

11. The system according to claim 8, wherein the data is received wirelessly and in real-time.

12. The system according to claim 8, wherein the data is received via a hardwire connection.

13. The system according to claim 8, wherein the floor plan includes a graphical representation illustrating at least one change in property of the at least one tribological level from a previously received tribological level.

14. The system according to claim 13, wherein the graphical representation is color-coded.

15. A non-transitory computer-readable storage medium storing a program which, when executed by a computer, causes the computer to perform a method for monitoring tribological levels, comprising the steps of:
receiving tribological data generated by a tribometer, the tribological data corresponding to at least one tribological level of a surface of at least one location;
associating the tribological data with a floor plan representing the at least one location; and
displaying the tribological data on the floor plan.

16. The non-transitory computer-readable storage medium according to claim 15, wherein the digital tribometer is a component of a robot that traverses the surface.

17. The non-transitory computer-readable storage medium according to claim 16, wherein the robot traverses the surface based on location identifiers included in the floor plan.

18. The non-transitory computer-readable storage medium according to claim 15, wherein the data is received wirelessly and in real-time.

19. The non-transitory computer-readable storage medium according to claim 15, wherein the data is received via a hardwire connection.

20. The non-transitory computer-readable storage medium according to claim 15, wherein the floor plan includes a graphical representation illustrating at least one change in property of the at least one tribological level from a previously received tribological level.
